(19) United States
(12) Patent Application Publication
(10) Pub. No.: US 2022/0331938 A1
(43) Pub. Date: Oct. 20, 2022

(54) Torque Screwdriver Structure

(71) Applicant: Rong-Suei Chan, Taipei City (TW)

(72) Inventor: Rong-Suei Chan, Taipei City (TW)

(21) Appl. No.: 17/231,104

(22) Filed: Apr. 15, 2021

(51) Int. Cl. B25B 23/147; B25B 23/142

(52) U.S. Cl. CPC B25B 23/1475; B25B 23/1427

(57) ABSTRACT

A torque screwdriver structure includes a first body assembly, a gauge holder, a second body assembly, a strain gauge, two fasteners, and a third body assembly. The first body assembly includes a first body, a motor, a planetary gear set, a first drive member, and a second drive member. The gauge holder is provided with a first receiving recess and a receiving slot. The second body assembly includes a second body, a display, and an abutting member. The second body is provided with a second receiving recess, a first opening, and a second opening. The strain gauge is mounted in the receiving slot and used to detect a torsion deformation of the gauge holder. The two fasteners secure the gauge holder to the second body. The third body assembly includes a third body, a connecting member, a power supply member, and two switches.

### BACKGROUND OF THE INVENTION

### 1. Field of the Invention

The present invention relates to a hand tool and, more particularly, to a torque screwdriver structure.

### 2. Description of the Related Art

A conventional battery-powered hand-held ratcheting torque wrench 10 was disclosed in the U.S. patent Ser. No. 10/625,405 (or Taiwanese Patent Publication No. M556196), and comprises an electric motor 18, a drive assembly 22, an output assembly 24, and a transducer assembly 118. The electric motor 18 has a motor drive shaft 20. The drive assembly 22 is coupled to the drive shaft 20 and driven by the electric motor 18. The output assembly 24 is coupled to the drive assembly 22 and includes an output member 102 (FIG. 1), such as a square head for receiving sockets. The output assembly 24 receives the torque from the drive assembly 22 so that the output member 102 is pivoted about an axis A. The transducer assembly 118 is mounted between the electric motor 18 and the output assembly 24. With reference to FIG. 7, the transducer assembly 118 is positioned inline and coaxial with the axis A, the motor 18, and the head 14. The transducer assembly 118 detects the torque output by the output member 102 when the wrench 10 is manually rotated about axis B (with the motor 18 deactivated), and indicates to a user (via a display device) when the torque output reaches a pre-defined torque value or torque threshold. For example, the wrench 10 may include a light emitting diode (LED) 124 (FIG. 5) for illuminating a workpiece during use of the wrench 10. But, in response to a pre-defined torque value or torque threshold being reached when the wrench 10 is manually rotated about axis B, the LED 124 may flash to signal the user that the pre-defined torque value is reached.

However, the conventional battery-powered hand-held ratcheting torque wrench 10 has the following disadvantages.

1. The output assembly 24 is initially assembled with the transducer assembly 118. The transducer assembly 118 is then assembled with the gear housing 36 of the drive assembly 22. The gear housing 36 of the drive assembly 22 is then assembled with the main housing 12. Thus, the components of the conventional battery-powered hand-held ratcheting torque wrench 10 are assembled serially so that the components are not assembled optimally.

2. As shown in FIGS. 1 and 5, the strain gauges 142 are directly mounted on the outside of the transducer assembly 118 and are exposed outward from the transducer assembly 118, so that the strain gauges 142 are easily damaged due to water erosion.

3. The conventional battery-powered hand-held ratcheting torque wrench 10 needs to provide the head 14, the transducer assembly 118, the gear housing 36, and the main housing 12, thereby complicating the construction, and thereby increasing the cost of fabrication.

### BRIEF SUMMARY OF THE INVENTION

In accordance with the present invention, there is provided a torque screwdriver structure comprising a first body assembly, a gauge holder, a second body assembly, a strain gauge, two fasteners, and a third body assembly. The first body assembly includes a first body, a motor, a planetary gear set, a first drive member, and a second drive member. The gauge holder is provided with a first receiving recess and a receiving slot. The second body assembly includes a second body, a display, and an abutting member. The second body is provided with a second receiving recess, a first opening, and a second opening. The strain gauge is mounted in the receiving slot and used to detect a torsion deformation of the gauge holder. The two fasteners secure the gauge holder to the second body. The third body assembly includes a third body, a connecting member, a power supply member, and two switches.

According to the primary advantage of the present invention, the first body assembly is received in the first receiving recess, with the driving portion protruding from a first end of the gauge holder, and with the motor protruding from a second end of the gauge holder. The first body assembly and the gauge holder are hidden in the second body, with the driving portion protruding from the second body. Thus, the first body, the gauge holder, and the second body are assembled exactly by the two fasteners and construct a laminating structure.

According to another advantage of the present invention, the force applying point is closer to the driving portion than the force resistant point, and when the second body is held and driven, the force resistant point is closer to the driven position of the second body than the force applying point, so that the force is transmitted reversely through the gauge holder to provide a better force applying state.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a torque screwdriver structure in accordance with the preferred embodiment of the present invention.

FIG. 2 is an exploded perspective view of a first body assembly of the torque screwdriver structure in accordance with the preferred embodiment of the present invention.

FIG. 3 is an exploded perspective view of a second body assembly of the torque screwdriver structure in accordance with the preferred embodiment of the present invention.

FIG. 4 is an exploded perspective view of a third body assembly of the torque screwdriver structure in accordance with the preferred embodiment of the present invention.

FIG. 5 is a top assembly view of the third body assembly of the torque screwdriver structure in accordance with the preferred embodiment of the present invention.

FIG. 6 is a partial perspective assembly view of the torque screwdriver structure in accordance with the preferred embodiment of the present invention.

FIG. 7 is a perspective assembly view of the torque screwdriver structure in accordance with the preferred embodiment of the present invention.

FIG. 8 is a top view of the torque screwdriver structure as shown in FIG. 7.

FIG. 9 is a cross-sectional view of the torque screwdriver structure taken along line A-A as shown in FIG. 8.

FIG. 10 is a partial exploded perspective view of a torque screwdriver structure in accordance with the second preferred embodiment of the present invention.

FIG. 11 is a perspective assembly view of the torque screwdriver structure in accordance with the second preferred embodiment of the present invention.

### DETAILED DESCRIPTION OF THE INVENTION

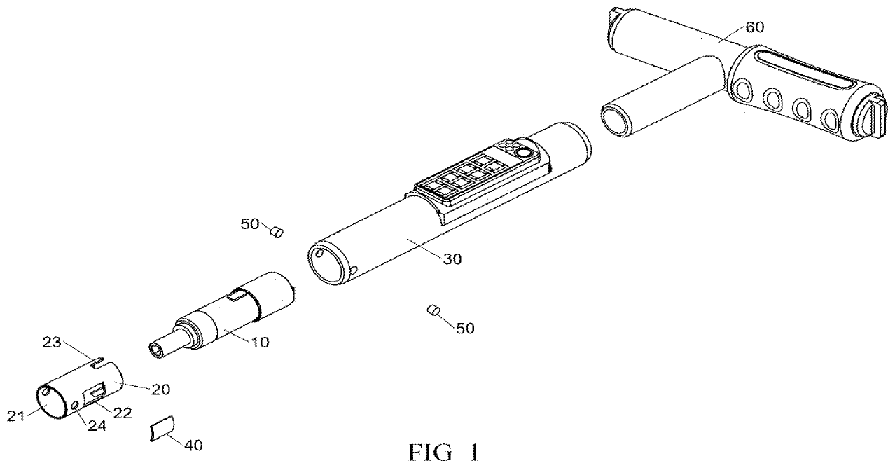

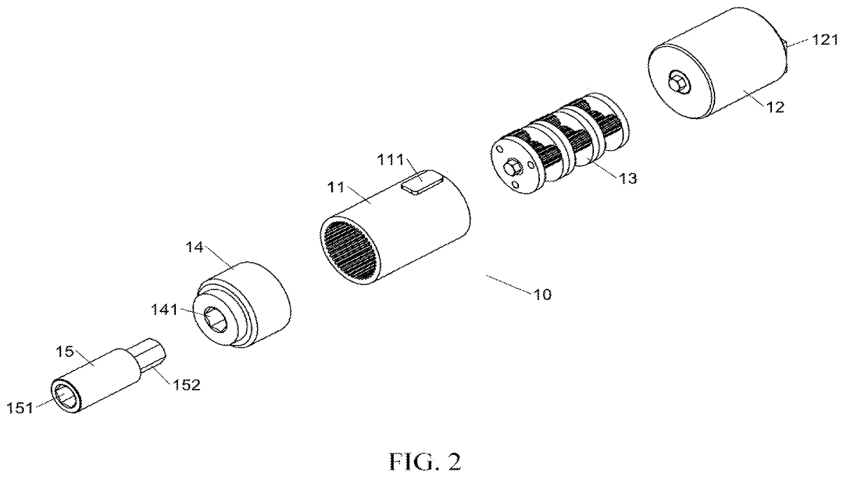

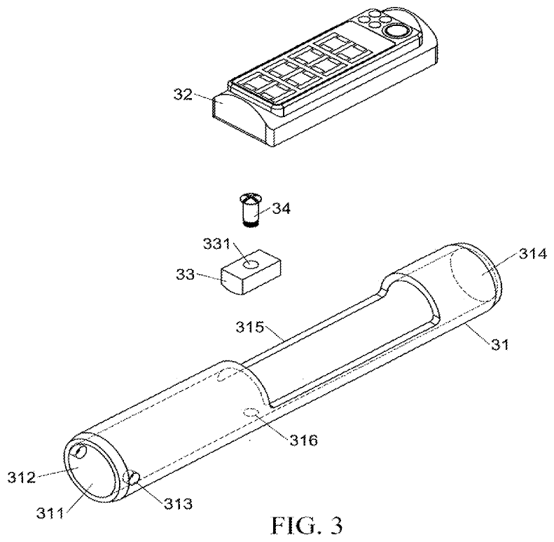

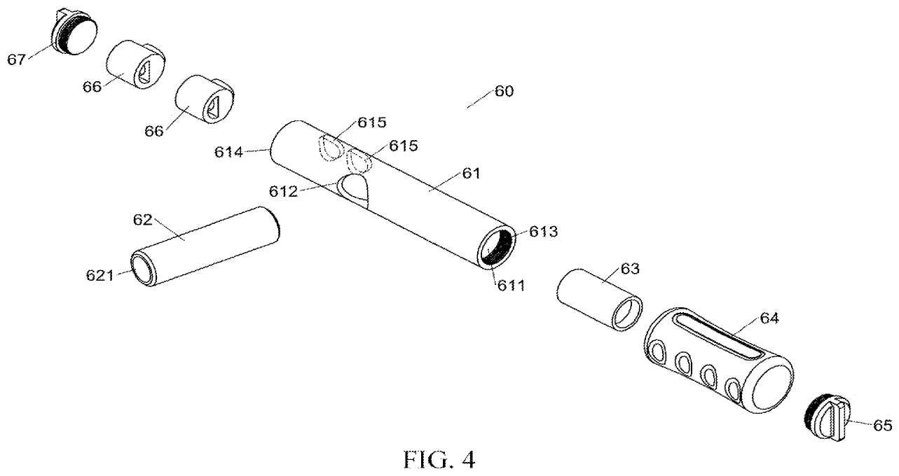

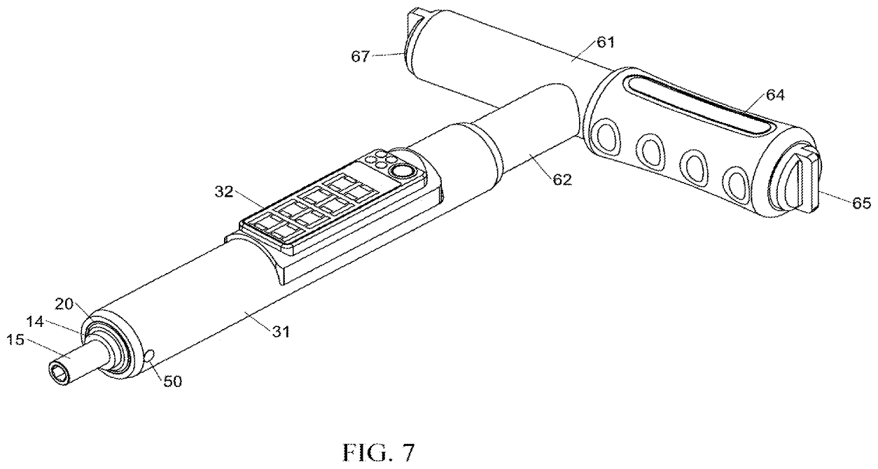

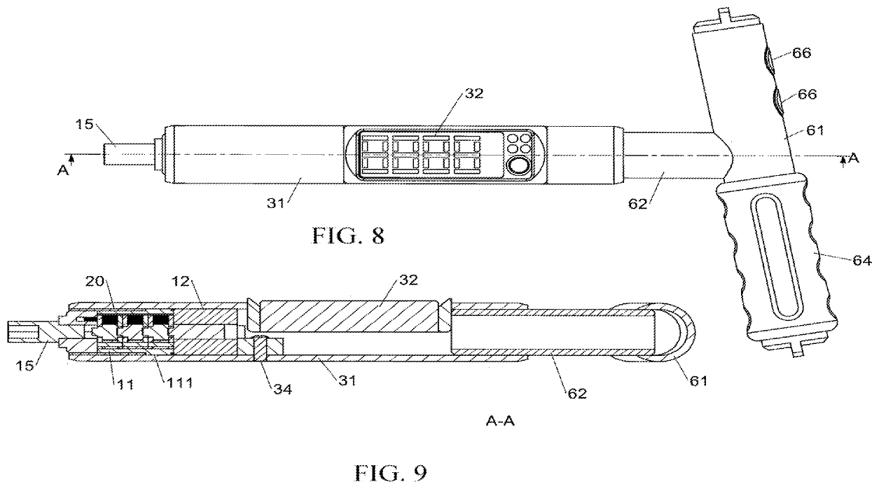

Referring to the drawings and initially to FIGS. 1-9, a torque screwdriver structure in accordance with the preferred embodiment of the present invention comprises a first body assembly 10, a gauge holder 20, a second body assembly 30, a strain gauge 40, two fasteners 50, and a third body assembly 60.

The first body assembly 10 includes a first body 11, a motor 12, a planetary gear set 13, a first drive member 14, and a second drive member 15.

The first body 11 is a hollow round rod or pole. The first body 11 has an outer peripheral face provided with at least one first mounting portion 111. The first mounting portion 111 is an elongate projection.

The motor 12 has a first end assembled with the first body 11 and a second end provided with at least one abutment 121. A rotation shaft protrudes from the motor 12.

The planetary gear set 13 is received in the first body 11 and has an end connected with the motor 12. The motor 12 drives the planetary gear set 13 to rotate in the first body 11.

The first drive member 14 has an end connected with the planetary gear set 13 which drives and rotates the first drive member 14. The planetary gear set 13 is arranged between the motor 12 and the first drive member 14. The first drive member 14 has an interior provided with a first fitting portion 141.

The second drive member 15 has a first end provided with a driving portion 151 and a second end provided with a second fitting portion 152. The second fitting portion 152 is distant from the driving portion 151 and fitted with the first fitting portion 141.

The gauge holder 20 is mounted on the first body assembly 10. The gauge holder 20 has a cylindrical shape and is provided with a first receiving recess 21. The first receiving recess 21 has a circular shape and penetrates the gauge holder 20. The first body assembly 10 is received in the first receiving recess 21, with the driving portion 151 protruding from a first end of the gauge holder 20, and with the motor 12 protruding from a second end of the gauge holder 20. The gauge holder 20 is provided with a receiving slot 22 connected to the first receiving recess 21. The gauge holder 20 has a first end provided with at least one second mounting portion 23 mounted on the at least one first mounting portion 111 so that the gauge holder 20 is restricted by the at least one first mounting portion 111 and cannot be rotated relative to the first body assembly 10. The at least one second mounting portion 23 has an open end. The gauge holder 20 has a second end provided with two first securing portions 24. The receiving slot 22 is arranged between the at least one second mounting portion 23 and the two first securing portions 24.

An angle of ninety degrees (90°) is defined between the at least one second mounting portion 23 and the receiving slot 22. A distance between the at least one second mounting portion 23 and the receiving slot 22 is close to or equal to that between the two first securing portions 24 and the receiving slot 22.

The second body assembly 30 receives the first body assembly 10 and the gauge holder 20, with the driving portion 151 protruding from the second body assembly 30. The second body assembly 30 includes a second body 31, a display 32, an abutting member 33, and a connecting member 34.

The second body 31 is provided with a second receiving recess 311 which penetrates the second body 31 transversely. The second body 31 has a first end provided with a first opening 312. The gauge holder 20 is mounted in the second receiving recess 311 and is close to the first opening 312. The second body 31 is provided with two second securing portions 313 aligning with the two first securing portions 24. The two second securing portions 313 are close to the first opening 312. The second body 31 has a second end provided with a second opening 314. The first opening 312 and the second opening 314 are arranged at two ends of the second receiving recess 311. The second body 31 is provided with a first passage 315 connected to the second receiving recess 311. The second body 31 is provided with a first connecting portion 316.

The display 32 is mounted in the first passage 315 and electrically connected with the motor 12. The display 32 includes multiple setting buttons and multiple indication monitors.

The abutting member 33 is mounted in the second body 31 and restricts the motor 12 so that the motor 12 is not moved and rotated in the second receiving recess 311. The abutting member 33 rests on the at least one abutment 121. The abutting member 33 is provided with a second connecting portion 331 aligning with the first connecting portion 316. The second connecting portion 331 penetrates the abutting member 33.

The connecting member 34 extends through the second connecting portion 331 and the first connecting portion 316, so that the abutting member 33 is secured to the second body 31.

The strain gauge 40 is mounted in the receiving slot 22 and electrically connected with the display 32. The strain gauge 40 is used to detect a torsion deformation of the gauge holder 20 and transmits the torsion deformation to the display 32 which indicates a torque when the torque screwdriver structure is rotated. When the torque reaches a preset value, the display 32 indicates the preset value and buzzes.

The two fasteners 50 extend through the two second securing portions 313 and the two first securing portions 24 to secure the gauge holder 20 to the second body 31. Thus, the gauge holder 20 is restricted by the two fasteners 50 so that the gauge holder 20 cannot be rotated relative to the second body 31 and will not be removed from the second receiving recess 311.

The two first securing portions 24 are proximate to the first opening 312, and the at least one second mounting portion 23 is distal to the first opening 312. The gauge holder 20 is secured to the second body 31 by the two fasteners 50, the first body assembly 10 is limited by the gauge holder 20 by engagement between the at least one first mounting portion 111 and the at least one second mounting portion 23, and the motor 12 is limited by the abutting member 33, so that the first body assembly 10 is not moved in the second body 31 and cannot be removed from the second body assembly 30.

The first body assembly 10 and the gauge holder 20 are hidden in the second body 31, with the driving portion 151 protruding from the second body 31.

When the driving portion 151 is mounted on a workpiece, the second body 31 is driven by a force to rotate the driving portion 151 so as to drive and rotate the workpiece. The two fasteners 50 connect the gauge holder 20 and the second body 31 and are served as a force applying point. The at least one first mounting portion 111 and the at least one second mounting portion 23 are served as a force resistant point. Thus, the force applying point is closer to the driving portion 151 than the force resistant point. In other word, when the second body 31 is driven, the force resistant point is closer to the driven position of the second body 31 than the force applying point. The strain gauge 40 is arranged between the force applying point and the force resistant point to detect the torsion state of the gauge holder 20. The force applying point and the force resistant point are hidden in the second body 31.

The third body assembly 60 is assembled with the second body assembly 30 and has a T-shaped profile. The third body assembly 60 includes a third body 61, a connecting member 62, a power supply member 63, and two switches 66.

The third body 61 has an interior provided with a third receiving recess 611. The third body 61 is provided with a second passage 612 connected to the third receiving recess 611. The third body 61 is provided with two third passages 615 spaced from each other.

The connecting member 62 has a first end mounted in the second passage 612 and a second end mounted in the second opening 314. The connecting member 62 connects the second body 31 and the third body 61. The connecting member 62 has an interior provided with a fourth receiving recess 621 which penetrates the connecting member 62.

The second receiving recess 311, the fourth receiving recess 621, and the third receiving recess 611 are connected to allow passage of an electric wire which connects the motor 12, the display 32, the power supply member 63, and the two switches 66.

The power supply member 63 is received in and can be removed from the third receiving recess 611. The power supply member 63 is electrically connected with the motor 12 and the display 32 to provide an electric power to the motor 12 and the display 32.

The two switches 66 are received in the third body 61 and mounted in the two third passages 615. The two switches 66 are electrically connected with the motor 12 and the power supply member 63 to start and rotate the motor 12 which drives and rotates the planetary gear set 13 which drives and rotates the first drive member 14 which drives and rotates the second drive member 15. One of the two switches 66 controls the motor 12 to rotate clockwise, and the other one of the two switches 66 controls the motor 12 to rotate counterclockwise. Thus, the motor 12 is rotated clockwise or counterclockwise by control of the two switches 66.

In the preferred embodiment of the present invention, the first body 11 has a plurality of first mounting portions 111 arranged in an annular shape about an axis of the first body 11. Alternatively, the first body 11 has two first mounting portions 111 opposite to each other. The first body 11 has an interior provided with a plurality of teeth arranged in an annular shape. The at least one abutment 121 is a cuboid or rectangular block. The first drive member 14 has a ring shape. The first fitting portion 141 penetrates the first drive member 14. The first fitting portion 141 is a hexagonal or tetragonal recess. The second drive member 15 is a circular rod. The driving portion 151 is a hexagonal recess or square head. The second fitting portion 152 is received in the first fitting portion 141.

In the preferred embodiment of the present invention, the at least one second mounting portion 23 has a number corresponding to that of the at least one first mounting portion 111. The at least one second mounting portion 23 is an elongate groove and is closely fitted onto the at least one first mounting portion 111. Each of the two first securing portions 24 is a circular screw hole. The two first securing portions 24 penetrate the gauge holder 20 and are arranged symmetrically.

In the preferred embodiment of the present invention, the second body 31 is a circular rod. The second receiving recess 311 has a circular shape. Each of the two second securing portions 313 is a circular screw hole. The first passage 315 is a rectangular channel. The first connecting portion 316 is a circular screw hole. The abutting member 33 is a cuboid. The second connecting portion 331 is a circular screw hole. The connecting member 34 is a threaded rod screwed through the second connecting portion 331 and the first connecting portion 316.

In the preferred embodiment of the present invention, each of the two fasteners 50 is a threaded rod or screw member screwed through each of the two second securing portions 313 and each of the two first securing portions 24.

In the preferred embodiment of the present invention, the third body 61 is a circular rod. The third receiving recess 611 has a circular shape and penetrates the third body 61 transversely. The second passage 612 has a circular shape. The third receiving recess 611 has a first end provided with a third opening 613 which is an internal thread. The third receiving recess 611 has a second end provided with a fourth opening 614 which is an internal thread. Each of the two third passages 615 has a circular shape and has an axis perpendicular to that of the third body 61. The connecting member 62 has a circular cross-sectional profile. The fourth receiving recess 621 has a circular shape. The power supply member 63 is close to the third opening 613. The power supply member 63 is a disposable or rechargeable battery. The third body assembly 60 further includes a handle 64 mounted on the third body 61. The handle 64 is proximate to the third opening 613 and distal to the fourth opening 614. The handle 64 has a cylindrical shape and has an outer face provided with a plurality of dimples to provide a nonslip function. The third body assembly 60 further includes a first end cover 65 mounted on the third opening 613. The first end cover 65 stops the power supply member 63 to prevent the power supply member 63 from being detached from the third body 61. The first end cover 65 has a circular shape and has an external thread screwed into the third opening 613. The third body assembly 60 further includes a second end cover 67 mounted on the fourth opening 614. The second end cover 67 stops the two switches 66 to prevent the two switches 66 from being detached from the third body 61. The second end cover 67 has a circular shape and has an external thread screwed into the fourth opening 614. The first end cover 65 and the second end cover 67 are arranged at two ends of the third body 61. The second end cover 67 is opposite to the first end cover 65.

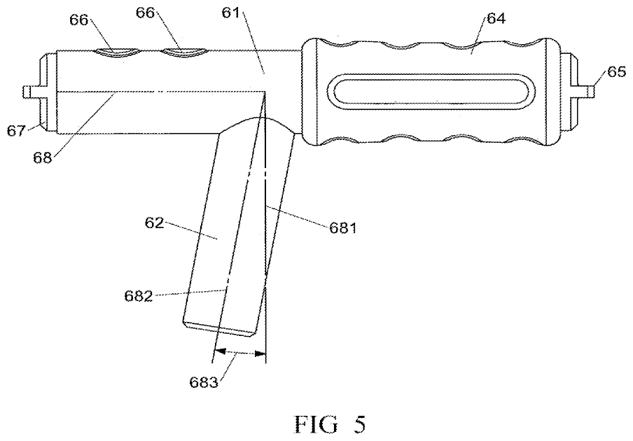

As shown in FIG. 5, the third body 61 has a first axis 68. A second axis 681 is perpendicular to the first axis 68. The connecting member 62 has a third axis 682. An angle 683 is defined between the second axis 681 and the third axis 682. Thus, the angle 683 indicates a deviation angle between the second body assembly 30 (or the connecting member 62) and the third body 61. The angle 683 is ranged between 5° and 20°. Preferably, the angle 683 is ranged between 8° and 16°. Optimally, the angle 683 is 10° or 12°.

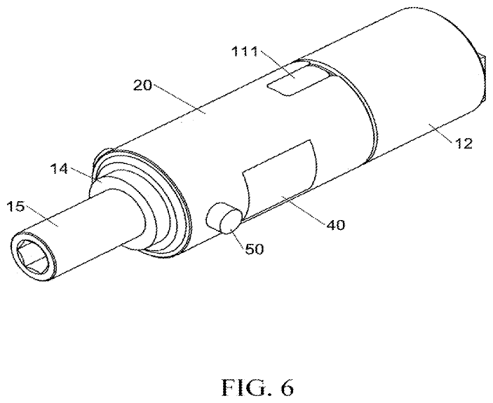

In assembly, referring to FIGS. 6-9 with reference to FIGS. 1-5, the first body assembly 10 is partially hidden in the second body assembly 30. The at least one second mounting portion 23 is mounted on the at least one first mounting portion 111 so that the gauge holder 20 is restricted by the at least one first mounting portion 111 and cannot be rotated relative to the first body 11 of the first body assembly 10. The display 32 is mounted in the first passage 315. The abutting member 33 is hidden in the second body 31. The strain gauge 40 is mounted in the receiving slot 22. The two fasteners 50 extend through the two second securing portions 313 and the two first securing portions 24 so that the gauge holder 20 cannot be rotated relative to the second body 31. The power supply member 63 is received and hidden in the third receiving recess 611 of the third body 61. The handle 64 is mounted on the third body 61. The first end cover 65 and the second end cover 67 are arranged at two ends of the third body 61. The connecting member 62 connects the second body 31 and the third body 61.

In operation, the motor 12 is started and driven by the two switches 66 to drive the planetary gear set 13 to rotate in the first body 11. The planetary gear set 13 drives the first drive member 14 and the second drive member 15 to rotate in the gauge holder 20 so as to drive and rotate the workpiece which is fitted in the driving portion 151.

Alternatively, when the second body 31 (or the third body 61) is rotated, the gauge holder 20 is rotated so that the first body assembly 10 is driven and rotated by the gauge holder 20. When the gauge holder 20 is rotated, the strain gauge 40 detects the torsion deformation of the gauge holder 20 and transmits the torsion deformation to the display 32 which indicates the torque of the torque screwdriver structure during rotation. When the torque reaches the preset value, the display 32 indicates the preset value and buzzes.

In such a manner, when the motor 12 in turn drives and rotates the planetary gear set 13, the first drive member 14, and the second drive member 15, the gauge holder 20 is not rotated, so that the strain gauge 40 cannot detect the torque. On the contrary, when the second body 31 (or the third body 61) drives and rotates the gauge holder 20 and the first body assembly 10, the gauge holder 20 is rotated, so that the strain gauge 40 can detect the torque.

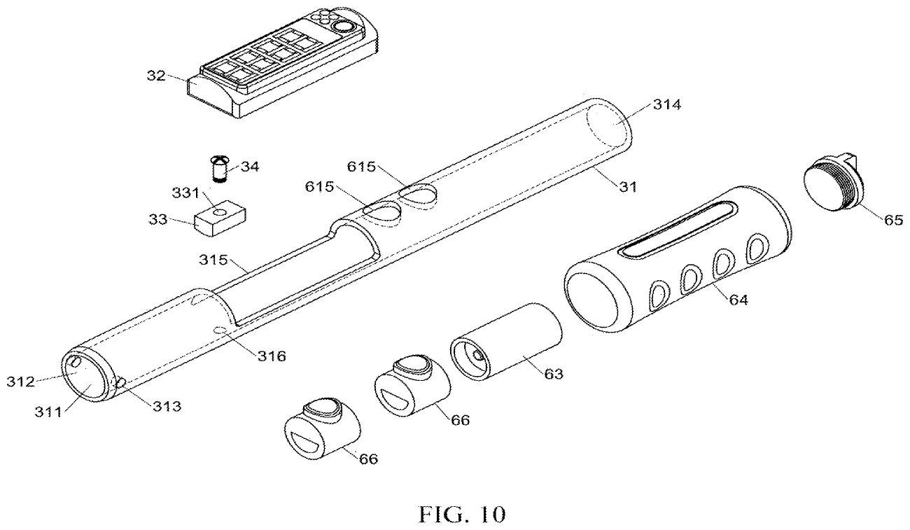

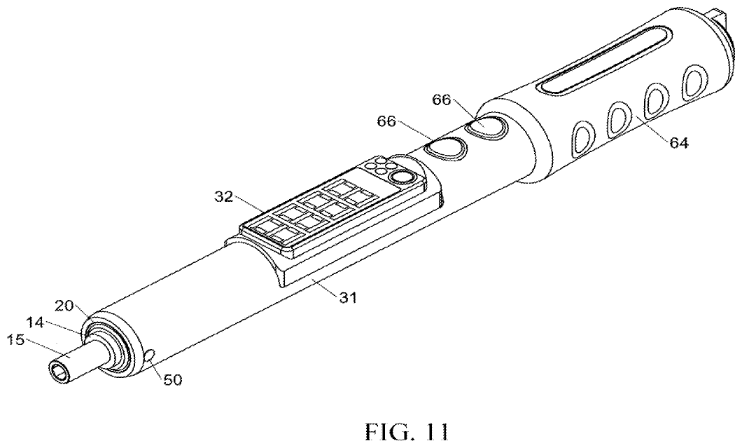

Referring to FIGS. 10 and 11 with reference to FIGS. 1-9, a torque screwdriver structure in accordance with the second preferred embodiment of the present invention is shown. The second body assembly 30 and the third body assembly 60 are combined integrally. The third body 61 is undefined, and the two third passages 615 are formed in the second body 31 and connected to the second receiving recess 311. The two third passages 615 are arranged between the second opening 314 and the first passage 315. Each of the two third passages 615 has an axis perpendicular to that of the second receiving recess 311. The power supply member 63 is received in the second receiving recess 311. The handle 64 is mounted on the second body 31 and proximate to the second opening 314. The second opening 314 is an internal thread. The first end cover 65 is screwed into the second opening 314. The two switches 66 are mounted in the second body 31. The two switches 66 are arranged between the display 32 and the handle 64.

In another preferred embodiment of the present invention, the first drive member 14 and the second drive member 15 are combined integrally. Thus, the first drive member 14 is integrally formed with the second drive member 15 and the driving portion 151.

In another preferred embodiment of the present invention, a first gasket is mounted between the gauge holder 20 and the second body 31, a second gasket is mounted between the gauge holder 20 and the first drive member 14, and a seal ring is mounted in the second opening 314, to prevent a liquid from flowing through the first opening 312 or the second opening 314 into the second receiving recess 311, so as to provide a liquid-proof function.

In another preferred embodiment of the present invention, the third body assembly 60 includes a switch 66. When the switch 66 is pressed, the motor 12 is controlled to rotate clockwise, and when the switch 66 is pressed again, the motor 12 is controlled to rotate counterclockwise.

Accordingly, the torque screwdriver structure has the following advantages.

1. The first body assembly 10 is received in the first receiving recess 21, with the driving portion 151 protruding from a first end of the gauge holder 20, and with the motor 12 protruding from a second end of the gauge holder 20. The first body assembly 10 and the gauge holder 20 are hidden in the second body 31, with the driving portion 151 protruding from the second body 31. Thus, the first body 11, the gauge holder 20, and the second body 31 are assembled exactly by the two fasteners 50 and construct a laminating structure.

2. The force applying point is closer to the driving portion 151 than the force resistant point, and when the second body 31 is held and driven, the force resistant point is closer to the driven position of the second body 31 than the force applying point, so that the force is transmitted reversely through the gauge holder 20 to provide a better force applying state.

3. The strain gauge 40 is arranged between the force applying point and the force resistant point to detect the torsion state of the gauge holder 20, while the force applying point and the force resistant point are hidden in the second body 31.

4. The gauge holder 20 is mounted on the second body 31 and limited by the two fasteners 50. The first body assembly 10 is limited by the gauge holder 20 and the abutting member 33 and cannot be moved in the second body 31, so that the first body assembly 10, the gauge holder 20, and the second body 31 have a better assembling construction.

5. The first body assembly 10 and the gauge holder 20 are hidden in the second body 31, so that the first body assembly 10, the gauge holder 20, and the strain gauge 40 are protected by the second body 31, thereby preventing the gauge holder 20 and the strain gauge 40 from being damaged due to drop, fall or hit.

6. The second body 31, the display 32, and the driving portion 151 construct the outward appearance of the torque screwdriver structure.

7. The strain gauge 40 is mounted in the receiving slot 22 to detect the torsion deformation of the gauge holder 20 and transmits the torsion deformation to the display 32 which indicates the torque or emits a warning signal when the torque reaches the preset value.

8. The two switches 66 controls the motor 12 respectively to rotate clockwise or counterclockwise.

9. Referring to FIGS. 10 and 11, the second body assembly 30 and the third body assembly 60 are combined integrally to reduce the cost of the torque screwdriver structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A torque screwdriver structure comprising:
a first body assembly, a gauge holder, a second body assembly, a strain gauge, two fasteners, and a third body assembly;
the first body assembly includes a first body, a motor, a planetary gear set, a first drive member, and a second drive member;
the first body has an outer peripheral face provided with at least one first mounting portion;
the first mounting portion is an elongate projection;
the motor has a first end assembled with the first body and a second end provided with at least one abutment;
a rotation shaft protrudes from the motor;
the planetary gear set is received in the first body and has an end connected with the motor;
the motor drives the planetary gear set to rotate in the first body;
the first drive member has an end connected with the planetary gear set which drives and rotates the first drive member;
the planetary gear set is arranged between the motor and the first drive member;
the first drive member has an interior provided with a first fitting portion;
the second drive member has a first end provided with a driving portion and a second end provided with a second fitting portion;
the second fitting portion is fitted with the first fitting portion;
the gauge holder is mounted on the first body assembly;
the gauge holder is provided with a first receiving recess;
the first body assembly is received in the first receiving recess, with the driving portion protruding from a first end of the gauge holder, and with the motor protruding from a second end of the gauge holder;
the gauge holder is provided with a receiving slot connected to the first receiving recess;
the gauge holder has a first end provided with at least one second mounting portion mounted on the at least one first mounting portion so that the gauge holder is restricted by the at least one first mounting portion and cannot be rotated relative to the first body assembly;
the at least one second mounting portion has an open end;
the gauge holder has a second end provided with two first securing portions;
the receiving slot is arranged between the at least one second mounting portion and the two first securing portions;
the second body assembly receives the first body assembly and the gauge holder, with the driving portion protruding from the second body assembly;
the second body assembly includes a second body, a display, an abutting member, and a connecting member;
the second body is provided with a second receiving recess;
the second body has a first end provided with a first opening;
the gauge holder is mounted in the second receiving recess;
the second body is provided with two second securing portions aligning with the two first securing portions;
the second body has a second end provided with a second opening;
the second body is provided with a first passage connected to the second receiving recess;
the second body is provided with a first connecting portion;
the display is mounted in the first passage and electrically connected with the motor;
the display includes multiple setting buttons and multiple indication monitors;
the abutting member is mounted in the second body and restricts the motor so that the motor is not moved and rotated in the second receiving recess;
the abutting member rests on the at least one abutment;
the abutting member is provided with a second connecting portion aligning with the first connecting portion;
the connecting member extends through the second connecting portion and the first connecting portion, so that the abutting member is secured to the second body;
the strain gauge is mounted in the receiving slot and electrically connected with the display;
the strain gauge is used to detect a torsion deformation of the gauge holder and transmits the torsion deformation to the display which indicates a torque when the torque screwdriver structure is rotated;
the two fasteners extend through the two second securing portions and the two first securing portions to secure the gauge holder to the second body;
the gauge holder is restricted by the two fasteners so that the gauge holder cannot be rotated relative to the second body;
the gauge holder is secured to the second body by the two fasteners, the first body assembly is limited by the gauge holder by engagement between the at least one first mounting portion and the at least one second mounting portion, and the motor is limited by the abutting member, so that the first body assembly is not moved in the second body;
the first body assembly and the gauge holder are hidden in the second body, with the driving portion protruding from the second body;
when the driving portion is mounted on a workpiece, the second body is driven by a force to rotate the driving portion so as to drive and rotate the workpiece;
the two fasteners connect the gauge holder and the second body and are served as a force applying point;
the at least one first mounting portion and the at least one second mounting portion are served as a force resistant point;
the force applying point is closer to the driving portion than the force resistant point;
when the second body is driven, the force resistant point is closer to the driven position of the second body than the force applying point;
the strain gauge is arranged between the force applying point and the force resistant point;
the third body assembly is assembled with the second body assembly;
the third body assembly includes a third body, a connecting member, a power supply member, and two switches;
the third body has an interior provided with a third receiving recess;
the third body is provided with a second passage connected to the third receiving recess;
the third body is provided with two third passages spaced from each other;
the connecting member has a first end mounted in the second passage and a second end mounted in the second opening;
the connecting member connects the second body and the third body;
the connecting member has an interior provided with a fourth receiving recess;
the second receiving recess, the fourth receiving recess, and the third receiving recess are connected to allow passage of an electric wire which connects the motor, the display, the power supply member, and the two switches;
the power supply member is received in the third receiving recess;
the power supply member is electrically connected with the motor and the display;
the two switches are received in the third body and mounted in the two third passages;
the two switches are electrically connected with the motor and the power supply member to start and rotate the motor which drives and rotates the planetary gear set which drives and rotates the first drive member which drives and rotates the second drive member;
one of the two switches controls the motor to rotate clockwise; and
the other one of the two switches controls the motor to rotate counterclockwise.

2. The torque screwdriver structure as claimed in claim 1, wherein:
the first body has a plurality of first mounting portions arranged in an annular shape about an axis of the first body;
the first body has two first mounting portions opposite to each other;
the first body has an interior provided with a plurality of teeth arranged in an annular shape;
the at least one abutment is a cuboid;
the first drive member has a ring shape;
the first fitting portion penetrates the first drive member;
the first fitting portion is a hexagonal recess;
the second drive member is a circular rod;
the driving portion is a hexagonal recess; and
the second fitting portion is received in the first fitting portion.

3. The torque screwdriver structure as claimed in claim 1, wherein:
the at least one second mounting portion has a number corresponding to that of the at least one first mounting portion;
the at least one second mounting portion is an elongate groove and is closely fitted onto the at least one first mounting portion;
each of the two first securing portions is a circular screw hole; and
the two first securing portions penetrate the gauge holder and are arranged symmetrically.

4. The torque screwdriver structure as claimed in claim 1, wherein:
the second body is a circular rod;
the second receiving recess has a circular shape;
each of the two second securing portions is a circular screw hole;
the first passage is a rectangular channel;
the first connecting portion is a circular screw hole;
the abutting member is a cuboid;
the second connecting portion is a circular screw hole; and
the connecting member is a threaded rod screwed through the second connecting portion and the first connecting portion.

5. The torque screwdriver structure as claimed in claim 1, wherein each of the two fasteners is a threaded rod screwed through each of the two second securing portions and each of the two first securing portions.

6. The torque screwdriver structure as claimed in claim 1, wherein:
the third body is a circular rod;
the third receiving recess has a circular shape and penetrates the third body transversely;
the second passage has a circular shape;
the third receiving recess has a first end provided with a third opening which is an internal thread;
the third receiving recess has a second end provided with a fourth opening which is an internal thread;
each of the two third passages has a circular shape and has an axis perpendicular to that of the third body;
the connecting member has a circular cross-sectional profile;
the fourth receiving recess has a circular shape;
the power supply member is close to the third opening;
the power supply member is a disposable or rechargeable battery;
the third body assembly further includes a handle mounted on the third body;
the handle is proximate to the third opening and distal to the fourth opening;
the handle has a cylindrical shape and has an outer face provided with a plurality of dimples;
the third body assembly further includes a first end cover mounted on the third opening;
the first end cover stops the power supply member;
the first end cover has a circular shape and has an external thread screwed into the third opening;
the third body assembly further includes a second end cover mounted on the fourth opening;
the second end cover stops the two switches to prevent the two switches from being detached from the third body;
the second end cover has a circular shape and has an external thread screwed into the fourth opening;
the first end cover and the second end cover are arranged at two ends of the third body; and
the second end cover is opposite to the first end cover.

7. The torque screwdriver structure as claimed in claim 1, wherein:
the third body has a first axis;
a second axis is perpendicular to the first axis;
the connecting member has a third axis;
an angle is defined between the second axis and the third axis; and
the angle is ranged between 5° and 20°

8. The torque screwdriver structure as claimed in claim 6, wherein:
the second body assembly and the third body assembly are combined integrally;
the two third passages are formed in the second body and connected to the second receiving recess;
the two third passages are arranged between the second opening and the first passage;
each of the two third passages has an axis perpendicular to that of the second receiving recess;
the power supply member is received in the second receiving recess;
the handle is mounted on the second body and proximate to the second opening;
the second opening is an internal thread;
the first end cover is screwed into the second opening;
the two switches are mounted in the second body; and
the two switches are arranged between the display and the handle.

9. The torque screwdriver structure as claimed in claim 1, wherein:
the first drive member and the second drive member are combined integrally; and
the first drive member is integrally formed with the second drive member and the driving portion.

10. The torque screwdriver structure as claimed in claim 1, wherein a first gasket is mounted between the gauge holder and the second body, a second gasket is mounted between the gauge holder and the first drive member, and a seal ring is mounted in the second opening, to prevent a liquid from flowing through the first opening or the second opening into the second receiving recess.

11. The torque screwdriver structure as claimed in claim 1, wherein:
the third body assembly includes a switch;
when the switch is pressed, the motor is controlled to rotate clockwise; and
when the switch is pressed again, the motor is controlled to rotate counterclockwise.
